(19) United States
(12) Patent Application Publication
(10) Pub. No.: US 2019/0171343 A1
(43) Pub. Date: Jun. 6, 2019

(54) SYSTEMS AND METHODS FOR DISPLAYING VIDEO CONTENT ON A WEBPAGE

(71) Applicant: Mediavine, Inc., Boca Raton, FL (US)

(72) Inventor: Eric Hochberger, Lighthouse Point, FL (US)

(21) Appl. No.: 16/207,685

(22) Filed: Dec. 3, 2018

Related U.S. Application Data
(60) Provisional application No. 62/593,486, filed on Dec. 1, 2017.

(51) Int. Cl. G06F 3/0484; G06F 16/74; G06F 16/958

(52) U.S. Cl. CPC G06F 3/0484; G06Q 30/0277; G06F 16/958; G06F 16/74

(57) ABSTRACT

A method and associated system for displaying video content on a computing device-accessed webpage including, under control of one or more processors configured with executable instructions, displaying a first video content item in a video adhesion unit on a webpage in response to accessing the webpage by a computing device, playing video content associated with the first video content item in the video adhesion unit on the webpage, locking the video adhesion unit to the webpage such that the video adhesion unit is continuously visible when accessing the webpage, conforming the video adhesion unit with the webpage on a basis of one or more visual attributes of the webpage, and providing user control functions for controlling the playing of the video content associated with the first video content item.

### CROSS-REFERENCE TO RELATED APPLICATIONS

The present application claims priority to U.S. Provisional Patent Application No. 62/593,486, filed Dec. 1, 2017, the disclosures and teachings of which are incorporated herein by reference.

### TECHNICAL FIELD

The present invention relates to a video adhesion unit for use in websites.

### BACKGROUND OF THE INVENTION

Video capabilities for websites often involve opening a desired video on different webpages or in different mobile applications, or embedding the video at a fixed location on a webpage. There is a need for an improved mechanism by which videos may be hosted and integrated into a website.

### SUMMARY OF THE INVENTION

In general, in one aspect, the invention features a method for displaying video content on a computing device-accessed webpage including, under control of one or more processors configured with executable instructions, displaying a first video content item in a video adhesion unit on a webpage in response to accessing the webpage by a computing device, playing video content associated with the first video content item in the video adhesion unit on the webpage, locking the video adhesion unit to the webpage such that the video adhesion unit is continuously visible when accessing the webpage, conforming the video adhesion unit with the webpage on a basis of one or more visual attributes of the webpage, and providing user control functions for controlling the playing of the video content associated with the first video content item.

Implementations of the invention may include one or more of the following features. The computing device may be a smartphone, a tablet, a laptop computer, or a desktop computer. The video adhesion unit may be locked to a webpage header or a webpage footer. The video adhesion unit may be configured to move in response to a scrolling of the webpage. The first video content item may be embedded with one or more tags or keywords associated with the subject matter of the webpage. The video content may be an advertisement, a video created by a publisher of the webpage, or a combination thereof. The one or more visual attributes of the website may include a webpage font type, a webpage font color, a webpage background, and a webpage color. The user control functions may be one or more of a pause video function, a stop video function, a restart video function, a mute video function, a video volume adjustment function, a maximize video function, a minimize video function, and a remove video function. The method may further include displaying a second video content item in a video adhesion unit on a webpage after playing the video content associated with the first video content item, and playing video content associated with the second video content item in the video adhesion unit on the webpage. The video content of the second video content item may be related to the video content of the first video content item.

In general, in another aspect, the invention features a system for displaying video content on a computing device-accessed webpage including one or more processors, one or more computer-readable media, and one or more modules maintained on the one or more computer-readable media that, when executed by the one or more processors, cause the one or more processors to perform operations including displaying a first video content item in a video adhesion unit on a webpage in response to accessing the webpage by a computing device, playing video content associated with the first video content item in the video adhesion unit on the webpage, locking the video adhesion unit to the webpage such that the video adhesion unit is continuously visible when accessing the webpage, conforming the video adhesion unit with the webpage on a basis of one or more visual attributes of the webpage, and providing user control functions for controlling the playing of the video content associated with the first video content item.

Implementations of the invention may include one or more of the following features. The computing device may be a smartphone, a tablet, a laptop computer, or a desktop computer. The video adhesion unit may be locked to a webpage header or a webpage footer. The video adhesion unit may be configured to move in response to a scrolling of the webpage. The first video content item may be embedded with one or more tags or keywords associated with the subject matter of the webpage. The video content may be an advertisement, a video created by a publisher of the webpage, or a combination thereof. The one or more visual attributes of the website may include a webpage font type, a webpage font color, a webpage background, and a webpage color. The user control functions may be one or more of a pause video function, a stop video function, a restart video function, a mute video function, a video volume adjustment function, a maximize video function, a minimize video function, and a remove video function. The system may further include additional operations including displaying a second video content item in a video adhesion unit on a webpage after playing the video content associated with the first video content item, and playing video content associated with the second video content item in the video adhesion unit on the webpage. The video content of the second video content item may be related to the video content of the first video content item.

### BRIEF DESCRIPTION OF THE DRAWINGS

FIG. 1 illustrates a first embodiment of the video adhesion unit and its use in a webpage.

### DETAILED DESCRIPTION OF THE INVENTION

The present invention is directed to a video adhesion unit utilized with websites and webpages. The video adhesion unit is configured to reside on a webpage and play one or more videos. In a preferred embodiment, the video adhesion unit is provided to a user when the user accesses the unit-hosting webpage via a mobile device or other computer.

In a preferred embodiment, the video adhesion unit is locked to the webpage view footer. Consequently, as the user scrolls down the webpage, the video adhesion unit remains in view, particularly at the bottom of the webpage view. In another embodiment, the video adhesion unit may be locked to the webpage view header or another location within the webpage view. In another embodiment, the video adhesion unit is not locked to a specific location of the webpage view but may move upon scrolling. In this embodiment, the video adhesion unit may remain visible to the user.

The video adhesion unit may play one or more videos upon accessing the unit-hosting webpage by a user. In one embodiment, the webpage publisher selects the one or more videos to be played. In another embodiment, videos are embedded with tags and/or keywords such that the one or more videos to be played are selected based on relevance of these embedded tags and/or keywords to the subject matter of the unit-hosting webpage.

The one or more videos may include advertisements, content created by the webpage publisher, other video content, and/or a combination of the aforementioned video content. In a preferred embodiment, the one or more videos begins with a pre-roll advertisement and follows with other video content, such as content created by the webpage publisher. If the one or more videos fails to load, the video adhesion unit may be configured to display itself as a traditional banner or a native display advertisement.

In another preferred embodiment, the video adhesion unit selects an advertisement to be played based on use of heading bidding and server-to-server connections and determination of the highest paying advertisement. If no such advertisement is determined and/or available, the video adhesion unit may be configured to display a traditional display advertisement.

The video adhesion unit may include traditional video player functions. These functions may include the ability to pause, stop, restart, mute, adjust the volume, maximize, minimize, and/or remove the video and/or the video adhesion unit. The video adhesion unit may also provide titles and/or information on current and/or upcoming videos. In a preferred embodiment, these titles and/or information are presented outside of the video but within the video adhesion unit, such as in the wrapper of the video adhesion unit. In another embodiment, the video adhesion unit may include a traditional banner and/or companion advertisement(s) alongside the one or more videos, such as in the wrapper of the video adhesion unit.

In another preferred embodiment, the video adhesion unit includes a smart playlist feature whereby, after the one or more videos have been played to completion, supplemental video content may be played. The supplemental video content may be relevant and/or related to the one or more videos. The supplemental video content may also include additional pre-roll advertisement(s) and/or traditional display advertisement fallback(s).

In a preferred embodiment, the video adhesion unit is configured to share attributes with the unit-hosting webpage, thereby blending into said webpage. This may be performed by matching fonts, colors, and the like of the video adhesion unit with that of the unit-hosting webpage.

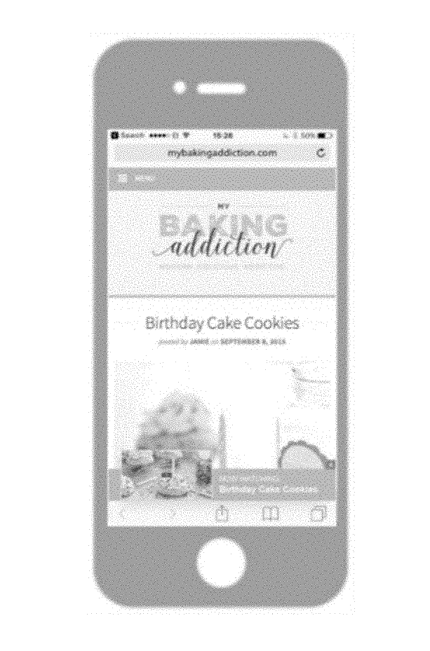

In the embodiment of the video adhesion unit shown in FIG. 1, the video adhesion unit is disposed at the webpage view footer. The webpage is accessed via a mobile device. The video adhesion unit includes matching elements to that of the unit-hosting webpage, such as the white banner/wrapper font color, the green banner/wrapper background color, and the banner/wrapper font type. The video element accounts for a portion of the video adhesion unit while the banner/wrapper accounts for the remaining portion of the video adhesion unit. Within the video element, the video includes certain video player functions, such as the ability to play and pause the video. The video adhesion unit also includes the ability to remove the entire video adhesion unit, as illustrated by the “X” box on the upper right-hand corner of the unit. Finally, the subject matter of the video content displayed in the video adhesion unit is relevant to that of the unit-hosting webpage. The embodiments and examples above are illustrative, and many variations can be introduced to them without departing from the spirit and scope of the disclosure or from the scope of the invention. For example, elements and/or features of different illustrative and exemplary embodiments herein may be combined with each other and/or substituted with each other within the scope of this disclosure. For a better understanding of the invention, its operating advantages and the specific objects attained by its uses, reference should be had to the drawings and descriptive matter, in which there is illustrated a preferred embodiment of the invention.

What is claimed is:

1. A method for displaying video content on a computing device-accessed webpage, comprising:
under control of one or more processors configured with executable instructions,
displaying a first video content item in a video adhesion unit on a webpage in response to accessing the webpage by a computing device;
playing video content associated with the first video content item in the video adhesion unit on the webpage;
locking the video adhesion unit to the webpage such that the video adhesion unit is continuously visible when accessing the webpage;
conforming the video adhesion unit with the webpage on a basis of one or more visual attributes of the webpage; and
providing user control functions for controlling the playing of the video content associated with the first video content item.

2. The method of claim 1, wherein the computing device is a smartphone, a tablet, a laptop computer, or a desktop computer.

3. The method of claim 1, wherein the video adhesion unit is locked to a webpage header or a webpage footer.

4. The method of claim 1, wherein the video adhesion unit is configured to move in response to a scrolling of the webpage.

5. The method of claim 1, wherein the first video content item is embedded with one or more tags or keywords associated with the subject matter of the webpage.

6. The method of claim 1, wherein the video content is an advertisement, a video created by a publisher of the webpage, or a combination thereof.

7. The method of claim 1, wherein the one or more visual attributes of the website include a webpage font type, a webpage font color, a webpage background, and a webpage color.

8. The method of claim 1, wherein the user control functions are one or more of a pause video function, a stop video function, a restart video function, a mute video function, a video volume adjustment function, a maximize video function, a minimize video function, and a remove video function.

9. The method of claim 1, further comprising:
displaying a second video content item in a video adhesion unit on a webpage after playing the video content associated with the first video content item; and
playing video content associated with the second video content item in the video adhesion unit on the webpage.

10. The method of claim 9, wherein the video content of the second video content item is related to the video content of the first video content item.

11. A system for displaying video content on a computing device-accessed webpage, comprising:
one or more processors;
one or more computer-readable media; and
one or more modules maintained on the one or more computer-readable media that, when executed by the one or more processors, cause the one or more processors to perform operations including:
displaying a first video content item in a video adhesion unit on a webpage in response to accessing the webpage by a computing device;
playing video content associated with the first video content item in the video adhesion unit on the webpage;
locking the video adhesion unit to the webpage such that the video adhesion unit is continuously visible when accessing the webpage;
conforming the video adhesion unit with the webpage on a basis of one or more visual attributes of the webpage; and
providing user control functions for controlling the playing of the video content associated with the first video content item.

12. The system of claim 11, wherein the computing device is a smartphone, a tablet, a laptop computer, or a desktop computer.

13. The system of claim 11, wherein the video adhesion unit is locked to a webpage header or a webpage footer.

14. The system of claim 11, wherein the video adhesion unit is configured to move in response to a scrolling of the webpage.

15. The system of claim 11, wherein the first video content item is embedded with one or more tags or keywords associated with the subject matter of the webpage.

16. The system of claim 11, wherein the video content is an advertisement, a video created by a publisher of the webpage, or a combination thereof.

17. The system of claim 11, wherein the one or more visual attributes of the website include a webpage font type, a webpage font color, a webpage background, and a webpage color.

18. The system of claim 11, wherein the user control functions are one or more of a pause video function, a stop video function, a restart video function, a mute video function, a video volume adjustment function, a maximize video function, a minimize video function, and a remove video function.

19. The system of claim 11, further comprising additional operations including:
displaying a second video content item in a video adhesion unit on a webpage after playing the video content associated with the first video content item; and
playing video content associated with the second video content item in the video adhesion unit on the webpage.

20. The system of claim 19, wherein the video content of the second video content item is related to the video content of the first video content item.
